(19) United States
(12) Patent Application Publication
(10) Pub. No.: US 2014/0115067 A1
(43) Pub. Date: Apr. 24, 2014

(54) METHOD AND SYSTEM FOR EMAIL ORGANIZATION

(71) Applicant: Josh Rosenwald, Lawrence, NY (US)

(72) Inventor: Josh Rosenwald, Lawrence, NY (US)

(73) Assignee: Unrollme Inc.

(21) Appl. No.: 13/654,621

(22) Filed: Oct. 18, 2012

(51) Int. Cl. G06F 15/16

(52) U.S. Cl. 709/206

(57) ABSTRACT

The present invention relates to methods and systems for segregating subscription emails into a single location where they can be organized, deleted, or otherwise managed separate from the user's regular email box.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and system for segregating desired email from an email system. In particular, it relates to a method for segregating subscription related emails and making a single site for unsubscribing and organizing subscription based emails.

2. Description of Related Art

The use of emails instead of regular mail has ended up with unusual problems. Because emails are sent at virtually no cost, the volume of junk mail is much larger than by regular US mail. Junk email or spam can take the form of advertisements, attacks on the computer, or the like and it's not unusual to get dozens of copies of the same email over a period of weeks or even months. It is known that there are several filters that work on the server side and on the computer user side to filter and isolate these unwanted emails.

A more recent phenomenon is the subscription email. They tend to come in a couple of ways. Subscriptions to newsletter or other regular mailings with information from one type of subscription are one type. Another type of subscription is an advertisement from a vendor that you visit or purchase items from and the vendor follows up with promotional information/topical information or both. Because virtually every web page visit can result in a subscription of some type, many email boxes tend to get overwhelmed over time. Twenty or thirty subscriptions could easily turn into dozens of emails a day. Because they tend to get mixed in with the emails we want and we may or may not want to read a subscription email, their presence and numbers has created a problem with subscription emails far outnumbering regular emails to the point they can be as much problem as junk email.

### BRIEF SUMMARY OF THE INVENTION

The present invention relates to a system for organizing a user's email subscriptions by sequestering them to a separate system server which can categorize them and keep them from cluttering a user email box without deleting the wanted subscription emails from the view by the user.

Accordingly, in one embodiment of the present invention there is a method for the organization of user email subscriptions in an email account of a user delivered to a user email server for delivery to the user inbox comprising:
a) a system server contacting the user email server and determining which emails in the user email server are user email subscriptions;
b) the system sever segregating the subscription emails to the system server;
c) classifying the subscriptions into at least a keep and unsubscribe classification; and
d) placing and organizing at least the keep emails in a user roll up email box on the system server accessible by the user over the internet.

### BRIEF DESCRIPTION OF THE DRAWINGS

FIG. 1 is a flow chart of the system invention.

FIG. 2 is a relationship chart of the present invention.

FIG. 3 is an exemplary screen shot of a system rollup user inbox.

FIG. 4 is an exemplary screen shot of a system rollup timeline box.

FIG. 5 is an exemplary screen shot of a system rollup category box.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “e-mail subscription” refers to an email user requesting that a particular organization, newsletter, e-zine, website, retailer, or the like, send the email user emails of newsletters, advertizing, topics, interest items, and the like either by physically signing up and providing an email address or in some instances automatically, for example, by visiting certain websites, buying certain products, or the like. The term is well known and the common element is these emails were somehow directly or indirectly requested as opposed to spam email which was never requested in any way. The result of signing up for a subscription is one or more regularly or irregularly arriving emails arrive at ones email box. In general, of the emails people receive that they have somehow requested (i.e. from co-workers, friends, etc.), subscriptions make up the largest percentage of received emails. Email subscriptions usually can also be unsubscribed, that is one can request all or a portion of the emails received by subscription be stopped or changed as desired. Most subscriptions have unsubscribe information right at the bottom of the email for the user to quickly and easily delete or change the subscription from the user's email account mailbox. Because subscriptions are a requested service, they usually can be changed or deleted. This is a time consuming and frequently difficult process especially because some subscriptions merely resign themselves up when a user revisits a website or the like. In general, in other embodiments it refers to any impersonal email, which broadly defined includes the following: any email that is required to have ease of unsubscription by the CAN-SPAM act (this covers advertisements); any advertisement, broadly defined, including ads for goods or services, events, etc. (the bulk of our service handles this type of email); any email that is sent to a mailing list, including political, discussion threads e.g. those that originate on Google Groups or Meetup, local business or organizations included churches and dubs, etc. (in short, if several or many people may receive an identical copy of an email, it falls under our domain); or automated receipts, package tracking information, financial statements, bills, from corporate entities, and other email that is analogous to letter mail a recipient would not throw away, even though it is from a corporate entity, Receipts and such that might be sent from one individual in a business transaction to another, e.g. an email reading “Just letting you know I received and cashed your check for the bugs,” we would not regard as impersonal email and this would fall outside our domain.

As used herein the phrase “organization of email subscriptions” refers to how email subscriptions being received by an email user are handled for the email user. The normal method is that they are delivered directly to the user's email box along with every other email. In the present invention they are organized by segregating the emails from the user's email box to a website where the user can view them when and how they want, including by date, sender, topic and the like.

As used herein an “email server” refers to a web based server which organizes all the emails received for a particular user and sends them to the user at their email address. For example, if one had a gmail account, Google's server would receive all the user's email and then send the user the email at regular intervals. If the server had spam filters, at least a portion of junk emails might be deleted before ever being delivered to the email user's account on their email user's computer, phone or the like.

As used herein a “system server” is a server on the internet that is part of the present invention method and system. The system server (including multiple servers which function to produce the desired effect) contacts the email server. The user when using the method of the present invention gives the server information to the system operator and the system server is programmed with the user information, email passwords, and the like to contact the email server and view the user's email at the server before the email is delivered to the email user. The system server can hold the subscription emails of the user that it isolates itself or that are moved to the system server by the email user. The server can also be used conventionally to eliminate unwanted emails to the trash but in a novel way (i.e. unwanted subscriptions).

As used herein a “rollup” is a collection of users subscripting emails on a system server collected in one place and organized by selected categories such as time, sender, topic and the like.

The system server contacts the email server in the present system and method and determines which of the user's emails on the email server are user subscription emails. Subscription emails are basically non-spam emails that are also non-personal emails (e.g. work, friends and family emails). In considering if an email is a subscription email, it can use one or more pieces of information as it looks at each email. The system will consider if an email is personal or not. Personal emails on some email systems are pre-identified with smart labels such as on Gmail. The system would ignore personal emails. It can look for a list ID field. For example, any email that is part of a list server might be considered a subscription. The system can check against a fixed list of senders. The user or the system operator can continuously review and add new senders who are identified as sending subscription emails. It can ignore emails as personal if they come from certain email accounts which are considered personal such as gmail.com, yohoo.com, aol.com, hotmail.com, and many other well known in the art. The system can ignore replies which it can determine from the heading of the email. It can ignore forwards. Two characteristics can mark an email as a forwarded email and not a subscription. First the system can check for the prefix fw or fwd in an email's subject. Second the text can be parsed in body for text determined to be in forwarded emails such as “from”, “date”, “subject”, “to” and the like. It can also check for keywords and links that indicate an email is a subscription or not. If the emails are an HTML email, the system can directly identify links by parsing the HTML. If the email is plain text, the system can identify the presence of a linking by searching for the string “http”. If an email has a link as well as a subscription keyword, such as “unsubscribe” or the phrase “manage your preferences” it is marked as a subscription. The system can check directly for an unsubscribe link. If a text from a list of keywords that are identified as appearing in an unsubscribe or preference management links appear, e.g. “unsub” or “websub” can be marked as a subscription. Yet another method would be for the system to look for image links. Any HTML email that includes an image that also includes a clickable link could be determined to be a subscription. Other methods could also be identified as time changes the way subscriptions are handled by the email sender. In any even any email not identified as a subscription is marked no subscription.

In determining the sender of an email, it's useful for the system server to identify the real world sender of the email. That can among other methods be determined by the name and domain. In one embodiment, any email from a selected individual sender is treated the same regardless of the name. As an example all emails with the domain meetup.com are treated the same regardless of the sender name.

In one embodiment of the present invention the system server maintains a constant connection to the email server. That way no emails on the email server evade detection by the system server by virtue of the email arriving and being sent to the user during a time the system server is not connected to the email server.

Once the system server identifies a series subscription emails, it moves those emails to the system server such that they can no longer be delivered to the email user. This can be done by any convenient method such as the system server and can maintain a persistent SSL IMAP connection to an email server so that email notification will occur. As soon as a new email is received it can be scanned as described above.

Once the subscription email arrives at the system server, the system server must classify the user's subscriptions and segregate it accordingly. That is, it determines what action to take with each email. Therefore in the present invention in one embodiment, email can be divided into fresh, unsubscribed, send to user inbox, and keep on system server. “Fresh” email as used herein is where the user has received no email from a sender since a long period of time or has never received anything, the email is then left in the user's inbox and in the user's rollup.

“Unsubscribed” as used herein refers to those emails the user has previously indicated are to be dropped and the user no longer wishes to receive. In one embodiment the unsubscribed function that is changing a subscribe subscription to unsubscribe can be done at any point and place in the system invention. That is, it can be done from the user's emails, the system website, or any other place determined to be accessible to unsubscribe. In one embodiment the emails can automatically be removed from the system after a selected period of time.

The system can remove an email that has been unsubscribed by any convenient means such as sending an unsubscribe to the sender (automatically or manually) or move the email to a system or the users trash. The user can place subscriptions in a list unsubscribe field. In one embodiment a request to unsubscribe is followed by a processing delay to give the user a chance to change their mind or correct an incorrectly unsubscribed subscription.

“Send to user's inbox” are those emails the user wants not to go to the system for organization but rather are sent in the normal way to the user's inbox. Lastly, all other subscriptions go to the system Inbox where they are organized and presented to the user over the internet.

The system places and organizes the fresh and keep emails in a roll up email box accessible by the user over the internet. The system can organize the emails for presentation any way that makes sense for organizing emails, such as by category, source, keyword topic and the like. Other categories such as news, shopping, travel, daily deals, social and the like can be utilized. Where there are competing categories, an email can go into it, can be placed in multiple categories, or the email can be weighted so that one category is more likely than another. In one embodiment a digest or summary of emails can be sent to the user's email box to let the user know what kind of emails have been received. In one embodiment a thumbnail of all emails that appear in the user's system inbox is utilized.

In one embodiment the emails can automatically be removed from the system after a selected period of time. In yet another the emails are merely deleted by the user from the system user inbox.

### The Figures

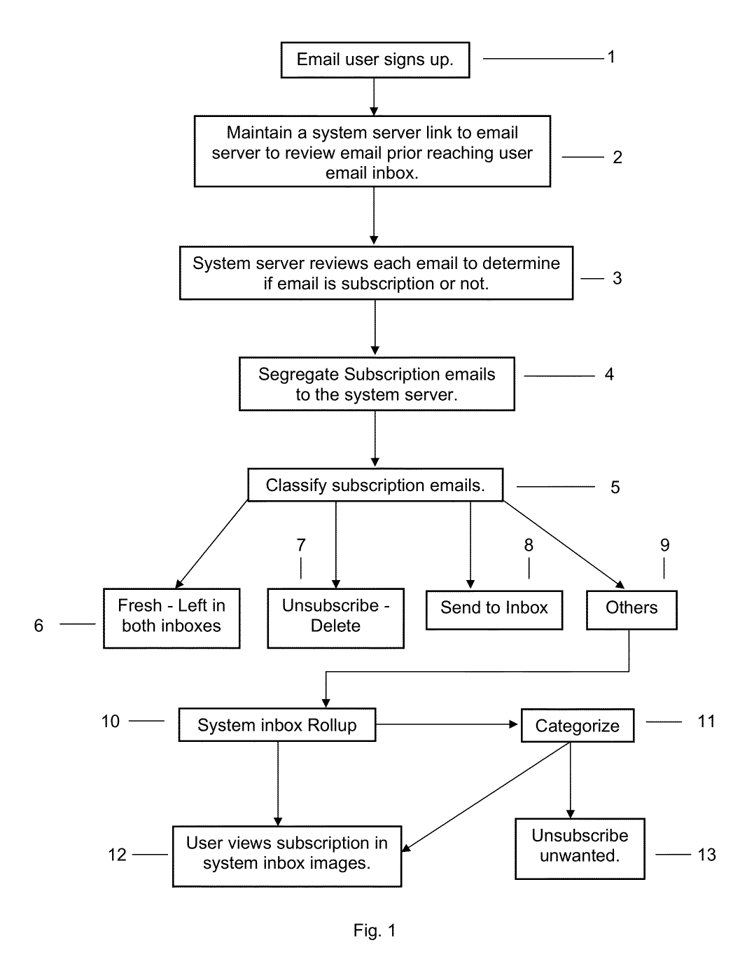

Now referring to the drawings, FIG. 1 is a flow chart of an exemplary system of the present invention. In the present invention a user of email signs up with the system 1. The system sever then reviews each email in the user's email server before delivery to the email user's personal email inbox to determine if an email is a subscription or not 2. As noted above the system can also determine those emails not yet classified and categorize them for a proper determination.

The system server maintains a constant or regular ping connection to the user's email server to review each user email prior to reaching the user 3. Once emails on the user's email server are determined to be subscription emails, the system segregates them from the user email server to the system server, thus preventing delivery of the emails to the user 4. The system then classifies subscription emails 5 into fresh 6, unsubscribe or delete 7, sent to user's inbox 8, or others 9. All others 9 are sent to the system server's user's inbox roll up 10 where they are categorized 11 into the desired categories wherein the user can then view his system inbox 12 whenever he wants to see the subscription emails or unsubscribe them from the system 13.

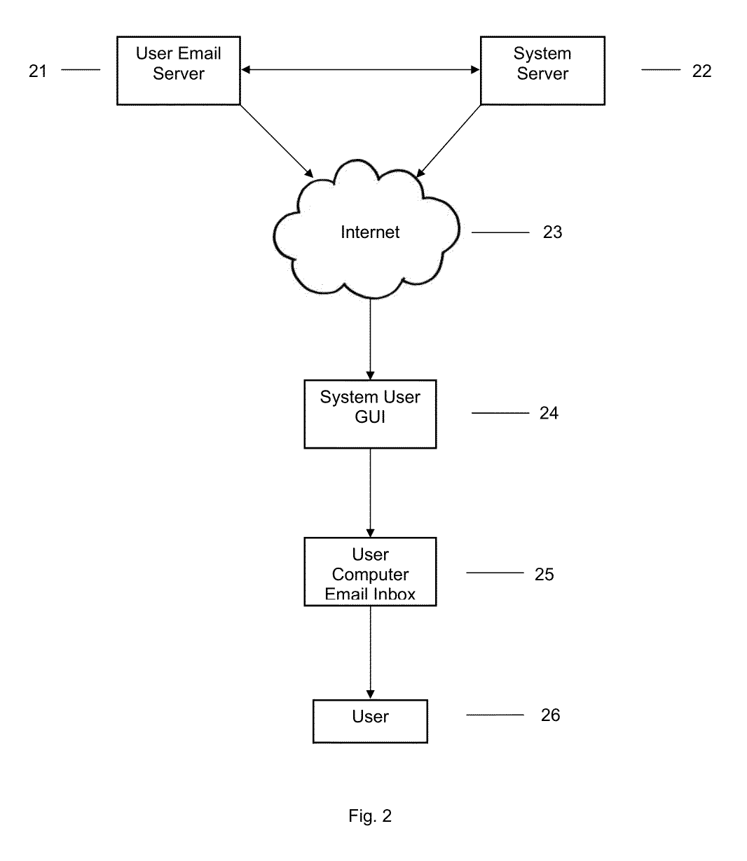

FIG. 2 is a system relationship figure. The user's email server 21 is connected to the system server 22. Both are connected to the internet 23 or currently available worldwide replacement of the internet. The user 26 utilizes their computer 25 and accesses a user graphic user interface (GUI) 24 to access the subscription emails on the system server.

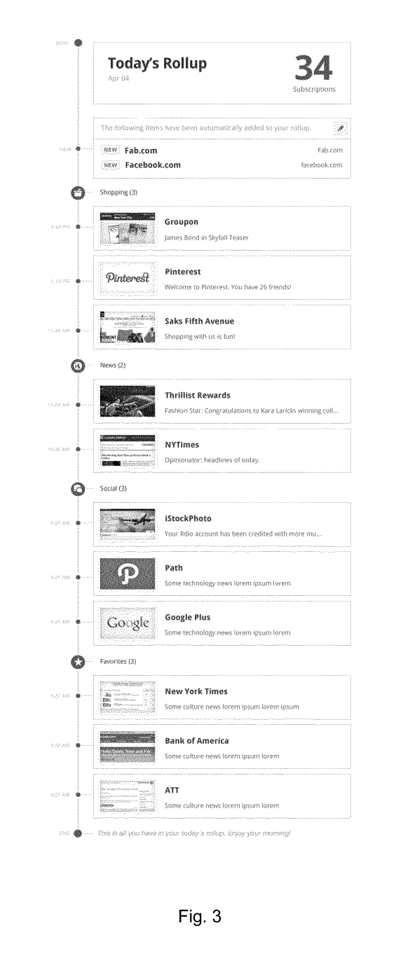

FIG. 3 is a sample screenshot of a roll up showing the organized subscription emails and thumbnails for each email.

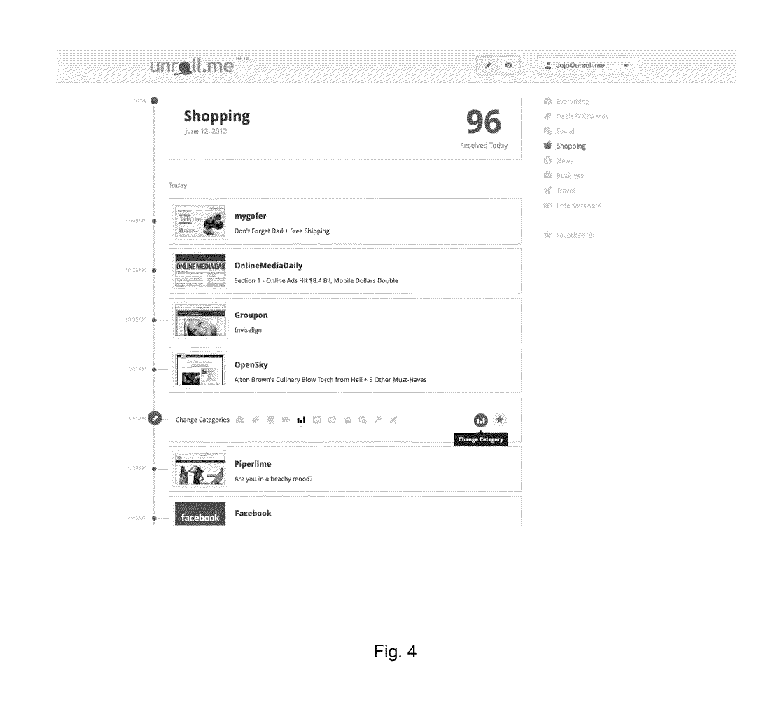

FIG. 4 is a sample screen shot of a roll up showing an original category page box (shopping).

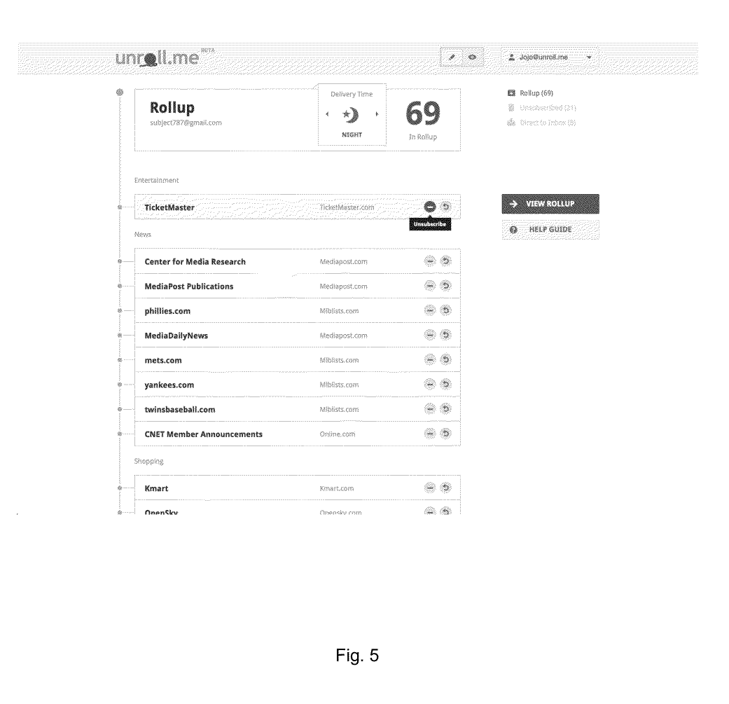

FIG. 5 is a sample screen shot of a roll up with a timeline box.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method for the organization of user email subscriptions in a first email account of a user wherein the email subscriptions are delivered to a user email server prior to delivery of the email subscription to the first email account comprising:
a) a system server contacting the user email server and determining which emails in the user email server are user email subscriptions the determination of which emails are not user email subscriptions being made by collecting and eliminating user emails in the system server which are:
i. not on a user email subscription list;
ii. scanned and do not contain one or more key word indicating the email is a subscription; and
iii. are determined to be spam or a personal email;
b) the system server segregating the subscription emails to the system server from the eliminated user emails;
c) classifying the subscriptions into at least a keep and unsubscribe classification; and
d) placing and organizing at least the keep emails in a second user roll up email box on the system server accessible by the user over the internet.

2. The method according to claim 1 where the user can move emails in the rollup email box to unsubscribe or send to user inbox.

3. The method according to claim 1 wherein fresh emails can be changed to unsubscribe, send to user inbox or keep a copy just in system server.

4. The method according to claim 1 wherein the emails are categorized into at least one of the group comprising, by timeline, by category, by source, by keyword, and by topic.

5. The method according to claim 1 wherein the system server sends a digest of the emails in the system server to the user email.

6. The method according to claim 1 where in the subscriptions are classified into fresh, unsubscribe, send to user inbox, and keep in system server.

7. The method according to claim 1 wherein the system server keeps a constant connection to the user email server to check for subscription emails.

8. The method according to claim 1 wherein the system server pings the user email server are regular intervals to check for subscription emails.
